(19) United States
(12) Patent Application Publication
(10) Pub. No.: US 2025/0190924 A1
(43) Pub. Date: Jun. 12, 2025

(54) Dynamic Multi-Queue Logistics System

(71) Applicant: Michael Gurin, Glenview, IL (US)

(72) Inventor: Michael Gurin, Glenview, IL (US)

(21) Appl. No.: 18/534,408

(22) Filed: Dec. 8, 2023

(51) Int. Cl. G06Q 10/083; G06Q 10/0631

(52) U.S. Cl. CPC G06Q 10/083; G06Q 10/06316

(57) ABSTRACT

The present invention relates to a logistics and vehicle infrastructure and integral feedforward control system maximizing asset value creation by enabling automated (particularly logistics and/or shared resources) vehicles by utilizing queueing and re-queueing assets and multi-queueing capacity within vehicles to enable vehicle routing with interspersed forward logistics and reverse logistics tasks. The feedforward control system further enhances broad system performance including determining a deployable re-queueing asset to maximize system utilization, user convenience, and energy efficiency.

### CROSS-REFERENCES

This patent application claims no priority.

### BACKGROUND OF INVENTION

Prior art includes virtually the entire field of delivery, whether it be automated or manual delivery systems, designed in most cases to meet one-way logistics delivery with most of the time being forward logistics. Additional prior art includes standard non-autonomous delivery systems where logistics dominates with organized forward logistics and relatively unorganized reverse logistics. The approximate delivery cost is represented by ˜50% being labor costs, ˜10% being energy costs, and delivery equipment costs also being ˜10%.

The global drive to decarbonization and electrification of everything places substantial demand on asset utilization, energy efficiency, and reduced embodied carbon dioxide. The latter in particular demands maximum utilization of deployed assets and structures. At the same time there is substantial demand on logistics speed and automation to support logistics by autonomous vehicles (i.e., driverless thus inability to easily achieve both logistics and reverse logistics). The inability of automated logistics vehicles to dock once at each destination while performing both logistics and reverse logistics from the same docking position leads to substantially higher operating and capital expenses therefore limiting the return of investment and the lifetime embodied CO2 footprint.

The shift of delivery vehicles to ultra-high energy efficiency autonomous vehicles substantially reduces the labor costs to practically zero, the energy costs to less than 30% of the previous non-high energy efficiency vehicles (i.e., fossil fuel internal combustion engine powered vehicles) and therefore most of the logistics costs become capital equipment costs of which levelized cost of delivery becomes dominated by utilization factor. The least expensive logistics delivery vehicle is a vehicle that maximizes the hours per annum of active operation. And therefore, a vehicle that maximizes the hours of operation must interface with docking infrastructure at all hours of day and night, meaning automation of loading and unloading must be integral to both the logistics vehicle(s) and docking ports. The lack of vehicle driver and docking worker demands new logistics infrastructure and vehicle needs to minimize logistics costs.

A need exists, therefore, for a multiple queueing vehicle system that enables a vehicle to perform sequentially forward logistics then reverse logistics (or reverse logistics then logistics, or even multiple queues of either reverse logistics or logistics) from a single vehicle docking position. It is understood that any reference to logistics (without “reverse”) is hereinafter equivalent to forward logistics. And a further need exists to decouple queueing order of logistics from reverse logistics deliveries, this is of particular importance for delivery of shared resources.

A further need exists for re-queueing assets to minimize travel distance and time when interspersing logistics delivery tasks with reverse logistics delivery tasks while in-transit.

Another need exists for a delivery vehicle to have multiple independent queues to extend the automated (or optimal efficiency) delivery options due to the interspersing of logistics and reverse logistics delivery tasks, especially when a reverse logistics task at a first location becomes a subsequent logistics task at a second location without the benefit of a re-queueing asset.

A need also exists to utilize a single docking position for proper sequencing of dischargeable cargo to be unloaded and loaded independently. It is understood that the docking position can be any docking system in which the process of loading and unloading dischargeable cargo takes place without the vehicle moving from the single docking position to a second docking position between loading (i.e., reverse logistics) and unloading (i.e., logistics) mode. One exemplary instance is the need to deliver a relatively full stored energy compactly and sequentially as the dischargeable cargo and return (or move) a relatively spent stored energy dischargeable cargo.

### FIELD OF INVENTION

The present invention generally relates especially to the field of autonomous vehicle transport predominantly for the movement of physical devices (as compared to people). More particularly, the present invention includes a dynamic queueing system that automatically enables interspersing of forward logistics and reverse logistics tasks and preferably a system that increases delivery sequencing by leveraging multiple queues within the delivery vehicle. The further inclusion of a feedforward control system, including and specifically for routing control, vehicle loading or unloading of physical devices, maximizes the asset value creation, minimizes the embodied carbon dioxide footprint, maximizes delivery efficiency, and minimizes travel time and distance.

### BRIEF SUMMARY OF INVENTION

The present invention relates to the integration of multiple queueing capabilities for a combined forward logistics and reverse logistics system, particularly for interspersed delivery tasks for forward logistics and reverse logistics, and especially for reverse logistics tasks that become new forward logistics tasks prior to reaching a re-queueing asset.

Another embodiment of the system is the vehicle executing the forward logistics and reverse logistics capabilities has at least two on-board queueing lanes with at least one lane position for receiving or discharging a dischargeable cargo.

Yet another embodiment of the system is the vehicle has a queueing movement capability to enable two positions within the at least one lane position enabling more sequencing options for receiving or discharging the dischargeable cargo.

Another embodiment of the system is a routing position optimized re-queueing asset to change the sequencing of dischargeable cargo already within at least one of the multiple queueing lanes, particularly when the reverse logistics dischargeable cargo is also serviced within the same re-queueing asset. As such the system also features dynamic addressing to properly place within a geographic mapping system where the dynamic addressing can be (and optimally) is a function of time recognizing that a re-queueing asset geographic position is optimally positioned as a variation of season, time of day, weekday vs. weekend, or solely the randomness of predicted, projected, or actually scheduled routing of reverse logistics tasks as exemplary variables that drive the optimal geographic position of the re-queueing asset.

Another embodiment of the system is a docking port in which the docking port services the vehicle from a single docking position for the at least two on-board queueing lanes.

Another embodiment of the system is one of the at least two on-board queueing lanes is servicing the vehicles on-board energy storage dischargeable cargo, notably where the on-board energy storage dischargeable cargo has a partial capacity of the aggregate on-board energy storage (even when the aggregate is comprised of substantially non-dischargeable cargo of energy storage).

Yet another embodiment of the system is the dischargeable on-board energy storage is less than 50% of the aggregate of on-board energy storage, also preferably where the dischargeable on-board energy storage has a depth of discharge cycle threshold that is at least 10% greater than the depth of discharge cycle threshold for the non-dischargeable on-board energy storage.

Another embodiment of the system is the vehicle has an energy storage controller capable of increasing the discharge rate of the dischargeable on-board energy storage by at least 10% greater than the discharge rate of the non-dischargeable on-board energy storage.

Yet another embodiment of the energy storage controller in which the discharge rate is a function of the next (or next two) charging stations as f(t) of the scheduled time at each projected docking port, the ability of the vehicle to reach by distance a next docking port and the projected scheduled time at each subsequent docking port.

Another embodiment of the vehicle is the at least two on-board queueing lanes are vertically shifted (one relatively above the other) or horizontally shifted (one relatively adjacent to the other), preferably where the primary (or heavier) of the dischargeable cargo is on the lower level when one lane is vertically shifted as compared to the other.

Yet another embodiment of the vehicle having at least two queueing positions is when a separate queueing position is predominantly for forward logistics and the other is predominantly for reverse logistics.

Another embodiment of the at least two queueing positions is when either of the queueing positions switches to a reverse logistics position temporarily when a subsequent reverse logistics task becomes a subsequent forward logistics prior to delivering a next reverse logistics or a next forward logistics task from within that queueing position.

Yet another embodiment of the system is a docking port to receive the vehicle such that the docking port has a vertical shift between a primarily forward logistics and a primarily reverse logistics queueing lane, a rotating queueing lane or a horizontal shift between 2 queueing lanes.

Another embodiment of the system is a feedforward control system to schedule routing for the vehicle (or preferably a fleet of vehicles) based at least in part on a real-time projected storage capacity within the at least two on-board queueing lanes. The feedforward control system dynamically routes the vehicle(s) based on queueing position and sequence.

Yet another embodiment of the feedforward control system schedules routing by the availability order for both forward logistics and reverse logistics tasks that convert at least a portion of the reverse logistics tasks into subsequent forward logistics tasks.

Another embodiment of the reverse logistics task queueing without any in-route conversion to forward logistics tasks are placed into a non-sequenced reverse logistics queueing lane. The system then leverages an in-route re-queueing asset(s) to enable proper sequential delivery of reverse logistics dischargeable cargo that must be delivered prior to arrival at a next re-queueing asset.

This summary is provided merely to introduce certain concepts and not to identify any key or essential features of the claimed subject matter.

### BRIEF DESCRIPTION OF DRAWINGS

FIG. 1—is a top view and two side views of the multi-queueing vehicle.

FIG. 2—is the multi-queueing vehicle with a rotating structure for the queueing lanes in the vehicle travel position or forward/rear vehicle docking alignment (onboard bottom view) as well as the rotating structure for the queueing lanes in the vehicle side docking alignment (offboard bottom view).

FIG. 3—is a top view where locations are dispersed on a map depicting their relative GPS position.

FIG. 4—is a data structure view for the multi-queueing vehicle along with a side view showing both passenger mode and logistics mode of operations.

FIG. 5—is a top view and a data structure view for the location with its queueing capabilities as well as docking ports for the multi-queueing vehicle(s).

FIG. 6 is a process logic flow diagram of the controller depicting the feedforward with feedback architecture.

### DEFINITIONS

The term “autonomous vehicle”, hereinafter also referred to as “AV”, is any movable device capable of operating without any onboard driver.

The term “discharged cargo” (also referred and interchangeable with “dischargeable cargo” or abbreviated as “DC”) includes a non-functional asset (in the context of the system or parked vehicle e.g., package or container) or a functional asset notably a battery charger that is in electrical communications with both a stationary plug to the parked vehicle and the integral power bus of the travel lane.

The term “queueing lane” is movement of dischargeable cargo within a controlled area that is physically or virtually constrained. It is understood that the spelling of queueing and queueing are used interchangeably.

The term “resequencing” (also referred and interchangeable with “re-queueing”) changes the order of individual DCs, relative to each other, within the queueing lane(s) such that the order of individual DCs is altered for subsequent discharges from the queueing lane(s).

The term “re-queueing asset” (also referred to as a resequencing asset) is a physical device capable of receiving at least two DCs from the queueing lane such that the order of discharges of each DC is subsequently changed, loaded back into a queueing lane (though understood that queueing lane is not necessarily on-board of the same vehicle) for the specific purpose of yet subsequent discharge order from that queueing lane that is different than the initial discharge order.

The term “service asset” is a physical device capable of performing an operational task on a DC. Exemplary operational tasks include washing dishes, cleaning clothing, charging energy storage devices, quality control checks such as confirming a lack of damage due to use of a shared resource prior to a next subsequent use of that share resource by a next user. It is understood that a service asset can have integral re-queueing capabilities in which case the service asset is also a re-queueing asset.

The term “feedforward and feedback loop control system” is the combination of controlling components (i.e., logistics movement vehicle utilization scheduling, DC delivery schedule requirement, and availability of re-queueing asset or service asset) first using a feedforward control system immediately followed by a feedback control system such that control parameters of the feedback control system are a function of the feedforward control system. For clarity, it is understood that the term control system is at least a feedback loop control system, and preferably a feedforward and feedback loop control system.

The term “forward logistics task” is the delivery of a DC at a discharge location in which the DC will be utilized at that discharge location. An exemplary Forward Logistics Task is a delivery of clean dishes and/or clean clothing, fully (or at least fuller than previously) charged energy storage device, delivery of food, delivery of on-line ordered product, etc.

The term “reverse logistics task” is the retrieval of a DC from a user location (in most instances a previous discharge location) in which that DC will be utilized again at a next discharge location, in many cases the DC will have a service task performed at a service asset prior to that next delivery. An exemplary Reverse Logistics Task is the retrieval of dirty dishes, dirty clothing, at least partially consumed energy from an energy storage device, post-service usage of a shared resource (e.g., tools, appliances), waste disposal recovery, dirty water, etc.

The term “service task” is an operational task including washing dishes, cleaning clothing, charging energy storage devices, quality control checks such as confirming a lack of damage due to use of a shared resource prior to a next subsequent use of that share resource by a next user.

### DETAILED DESCRIPTION OF THE INVENTION

Here, as well as elsewhere in the specification and claims, individual numerical values and/or individual range limits can be combined to form non-disclosed ranges.

Exemplary embodiments of the present invention are provided, which reference the contained figures. Such embodiments are merely exemplary in nature. Regarding the figures, like reference numerals refer to like parts.

The inventive multiple queueing infrastructure system and the vehicles also featuring multiple queueing lanes is particularly both novel and a necessity for autonomous vehicles, as the lack of a driver for moving the vehicle from a first location to a second location also means there is a lack of loaders and unloaders of cargo (at least that are roaming with the vehicle) from the vehicle. The constraint of no cargo movers on-board the vehicle virtually eliminates the potential to change sequencing of discharging cargo once the DC has been loaded onto the vehicle, which also with virtual certainty eliminates the potential to onboard DC in a reverse logistics scenario without constraining subsequent DCs already loaded for a forward logistics scenario thus forcing a routing that discharges the reverse logistics DC prior to any subsequent (blocked in) forward logistics DC(s). The inventive vehicle therefore has multiple queueing lanes to enable reverse logistics DC to be interspersed with forward logistics DC.

Interspersing for a combined forward logistics and reverse logistics system with the integrated vehicle having multiple queueing lanes is necessary for reverse logistics tasks that then subsequently become new forward logistics tasks unless resequencing is available. The inventive system has at least one re-queueing asset available. The preferred embodiment has both multiple re-queueing assets deployed throughout the delivery geofence, and specifically preferred the re-queueing assets themselves are re-deployable to a location that itself is determined by the feedforward control system to minimize both incremental travel distance (beyond actual delivery points) and travel time based on actual known delivery and pickup points (or projected, preferably based on historic data). The re-queueing asset preferably has a docking port in which a delivery vehicle can either individually one at a time unload onboard DCs in sequence into the re-queueing asset or preferably group unload multiple DCs into the re-queueing asset. The re-queueing asset subsequently varies the sequence of DCs such that reloading of the DCs onto the delivery vehicle, whether it be the same first delivery vehicle or a different second delivery vehicle, is now in a new sequence for loading into the delivery vehicle's multiple queueing lanes (or even a single queueing lane) based on the feedforward control system's determined routing sequence for both forward logistics and reverse logistics (when multiple queueing lanes, or just forward logistics when single queueing lane).

A preferred vehicle has at least two on-board queueing lanes, and a particularly preferred queueing lane has at least one lane position for receiving or discharging a dischargeable cargo. The specifically preferred queueing lane has one first DC accessible end of the queue capable of discharging a first DC and another second DC accessible end of the queue capable of onboarding a second DC. This inventive capability enables the vehicle to maintain a higher loading factor (i.e., closer to the to the 100% capacity) for the duration of the delivery vehicle routing sequence and very importantly to virtually eliminate the delivery vehicle from returning empty (typically to a distribution warehouse), which otherwise makes the net delivery cost more expensive by at least 10% in terms of energy efficiency and asset utilization effectiveness, by picking up reverse logistics DC interspersed between deliveries of forward logistics DC. The optimal routing is an especially complex problem requiring another inventive feature of a feedforward control system, as the routing sequence must not only track the minimum travel distance (as known in the art) but importantly also track queueing position within available capacity for each queueing lane to determine the routing sequence. Without the inventive queueing lanes and feedforward control system the delivery vehicle would operate identically to the predominance of the logistics industry. A non-inventive scenario considered optimal in the logistics industry is finding a reverse logistics opportunity BUT only until all forward logistics requirements are completed in relative proximity to the routing from that point in which the delivery vehicle is empty and back to a desired destination for that same delivery vehicle. This means the current state of the art has a lower loading factor as all (or virtually all, meaning at least 90% and more typically at least 95%) forward logistics DCs must be discharged prior to any subsequent loading of reverse logistics DCs in addition to an inherent delay for any reverse logistics DCs to arrive at their respective destination.

The particularly preferred vehicle within the multiple queueing system has a queueing movement/reconfiguration capability (relative to its position within the vehicle) to enable two access positions within at least one of the multiple queueing lanes. This inventive feature breaks the shortcoming of otherwise discharge sequence being limited to last in first out “LIFO”. Eliminating this shortcoming is necessary as otherwise a reversible logistics DC would prevent any remaining forward logistics DC to be delivered without discharging (i.e., unloading) the reverse logistics LIFO sequence every time a forward logistics DC needs to be unloaded. Unnecessary unloading of traffic limiting DC (and then of course reloading of that same DC) requires more vehicle idle time, more physical space at the docking port, and/or more sophisticated automated equipment at the docking port or even worst requiring manual labor thus reducing the advantages of autonomous operations. Every queueing lane that has multiple access points is capable of more sequencing options for receiving or discharging the dischargeable cargos. A fundamental advantage of the delivery vehicle being autonomous is optimized when the delivery vehicle docks into a docking port that also enables autonomous operations, and preferably is such that the autonomous docking port with integral security features such that a DC transfers from the delivery vehicle to a secure parking/holding spot (i.e., buffer parking in which it is effectively impossible for unauthorized access). This feature is particularly essential when the unloading of a forward logistics DC or loading of a reverse logistics DC takes place throughout the 24-hour time schedule, which is a fundamental requirement in order to effectively ensure that the delivery vehicle has maximum hours of operation (which is critical for rapid asset amortization thus reducing the true logistics costs that is based on both capital “Capex” and operating “Opex” cost accounting principles as known in the art). Logistics supporting a residential facility, whether it be a multi-family or individual residence, most often requires DC transfer without the benefit of a loader/unloader. An exemplary instance is loading of dirty dishes from the day (through dinner) via reverse logistics for optimal washing at a relatively centralized location (to maximize utilization of the dish washing asset) during the evening and return of those now clean dishes (or in the instance of shared assets such as dishes other identical or at least interchangeable clean dishes) in the morning (or at least prior to the next usage). Another exemplary is the delivery of stored energy assets (whether it be electrical or thermal) especially for the purpose of reducing peak demand regardless of whether the peak demand is in the middle of a workday or the night. The optimal inventive docking port also has multiple queueing lanes (or a single queueing lane in which the lane has at least two access points in which a forward logistics DC (from the context of the delivery vehicle) and a reverse logistics DC (also from the context of the delivery vehicle) can both be transferred autonomously and securely.

Yet another imperative of the inventive system is that the vehicle can dock at docking port while enabling maximum access to each of the multiple access points without the vehicle needing to physically move positions at the docking port, as this would substantially increase the idle time in which the delivery vehicle would remain at the location having the docking port for loading and/or unloading of the DC. As mentioned above the logistics movements of shared resources particularly demand interspersed forward logistics tasks and reverse logistics tasks. As noted, exemplary forward logistics tasks and reverse logistics tasks include the receiving of clean dishes and sending dirty dishes for off-site cleaning (having the benefit of reduced on-site energy consumption) and more optimal waste recovery for subsequent biofuels production. Reducing on-site energy consumption has cascading benefits by reducing the number of deliveries required for movement of energy storage assets providing such on-site energy consumption. The multiple queueing system enables and empowers a substantial reduction in on-site energy consumption while also substantially increasing the asset utilization of relatively high-power consuming assets. In this instance of a residence, especially in view of the relatively dramatic increase in energy efficiency of lighting luminaires, computer microprocessors, consumer appliances (e.g., TVs, refrigerators). A residence that receives stored thermal energy to meet the requirements for domestic hot water, air conditioning and heating, and preferably refrigeration therefore has substantially reduced electrical energy requirements (i.e., electrical battery storage, which is substantially higher in capital costs as compared to thermal energy storage) therefore requires at least 10% reduced delivery trips (and preferably at least 20%, and particularly preferred at least 30% reduced delivery trips). Another inventive feature of the multiple queueing system, which has particular significance in reducing the capital cost of a residential asset, is the elimination of on-site consumer appliances without any effective sacrifice of convenience and comfort. The benefits are cascading as the residence reduces the electrical load substantially thus enabling more low-voltage electrical distribution as compared to relatively higher voltage (typically alternating current) electrical distribution requiring rigid conduit. Importantly that same residence requires less square footage as a laundry room is no longer required (as well as the actual washing machine and dryer appliances) and the kitchen no longer requires a dish washer (along with all its energy and water requirements). The inventive multiple queueing system reduces the residential on-site energy requirements by at least 10% (and preferably at least 30%, and particularly preferred at least 50%) as compared to residential on-site energy requirements without having shared assets (e.g., dishes, and consumer appliances). Carrying this even further, the delivery vehicle with multiple queueing lanes and even better with reconfigurable interior space, can eliminate the vehicle garage space. In a typical United States suburban home this can amount to a residence space reduction of at least 400 square foot (which at today's cost per square foot more than USD 200 per square foot) amounts to a reduction of USD 80000 per residence, plus the actual costs of the consumer appliances).

Another exemplary is the delivery vehicle receiving of a fully charged energy storage device (e.g., battery) for subsequent power demand reduction at a second location as delivered by the delivery vehicle and prior swapping from the delivery vehicle a less than fully charged energy storage device for off-site charging services preferably at a combined service asset and re-sequencing asset. It is understood that any combination of forward logistics DCs and reverse logistics DCs can be respectively unloaded and loaded (further understood that a multiple queueing lane vehicle can load first then unload second, or unload first and then load second in a time sequence).

As noted above, another embodiment of the system is a docking port in which the docking port services the delivery vehicle from a single docking position (i.e., the delivery vehicle aligns and docks only once into the docking position) with an individual docking port providing direct access of DCs for at least two on-board queueing lanes, whether a first on-board queueing lane is a forward logistics queue and a second on-board queueing lane is a reverse logistics queueing lane or at least two queueing lanes are both forward logistics queues (therefore providing more delivery sequencing routing), or in fact an entire forward logistics queueing lane subsequently transitions to a reverse logistics queueing lane (or vice versa) while in transit of the entire delivery route.

The transition of delivery vehicles from internal combustion engines to electric vehicles has substantial benefit in terms of environmental impact, however as recognized the recharging (i.e., analogous to refueling) time is substantially greater than refueling with liquid transportation fuels or even hydrogen or natural gas. This increase in time is of disadvantage for high utilization factor vehicles, which in fact is a primary advantage of the multiple queueing lane vehicles. Therefore, the inventive delivery vehicle has at least a portion of the vehicles energy storage assets stored within one of the queueing lanes. The high frequency of services required in the enabled sustainable community has the benefit of an overwhelming number of short trips, as well as deployable re-queueing assets, in which stored energy can be rapidly swapped. Therefore, a cascading benefit of the inventive system enables substantially lower vehicle range requirements, that translates to a higher per distance efficiency as a substantial reduction of batteries is required and therefore its high weight yields the benefit of a reduced vehicle cost through lower acceleration and deceleration forces, and lower tire rolling resistance. As noted, the on-board energy storage for the delivery vehicle has the same fundamental advantages and requirements for autonomous loading & unloading. It is imperative that the queueing of battery storage assets doesn't interfere with the order of primary DC forward and reverse logistics assets in the logistics system. Having a portion of the on-board energy storage being fundamentally accessible for swapping concurrently with the loading/unloading of DCs in a separate queue is highly advantageous. The specific placement of the onboard energy storage queue in between the at least two multiple queueing lanes servicing the forward and reverse logistics DCs enhances the vehicles center of gravity, provides a physical barrier maintaining alignment of DCs in each queue.

Energy storage swapping of substantially smaller capacity modules via the queueing lanes has value for autonomous vehicles as the absence of a driver reduces the otherwise operating costs of a non-autonomous attributed to a driver that is waiting for the vehicle to charge. The energy storage swapping further enables the smaller capacity modules to have extended lifetime by avoiding the more damaging fast charge relative to slower Level 2 energy storage charging. It is known in the art that battery charging at a fast rate is more damaging to battery lifetime as compared to discharging at a fast rate. And there is no better time to swap substantially discharged smaller capacity modules via the queueing lane rapidly while dischargeable cargo is concurrently being loaded or unloaded from a parallel queueing lane, especially when the time to load or unload the dischargeable cargo within the inventive multi-queueing lane system is optimized for rapid processing.

A fundamental advantage of the center energy storage “battery” queue is an inherent sound protection barrier between the left side and right side of the vehicle therefore providing enhanced comfort to passengers even when passengers may occupy only a single side of the vehicle at a time and when passengers occupy both sides of the vehicle. An imperative feature of the vehicle is to obtain very high utilization rates therefore essentially demanding the vehicle to transition from logistics mode to passenger mode (or mixed mode). Further given the autonomous nature of the vehicle, the vehicle must also enable rapid transition between logistics mode to passenger mode and particularly preferred is the transition itself also being autonomous. The inventive center queue not only provides integral transit storage of a small capacity energy storage battery (i.e., total vehicle range of less than 50 miles, preferably less than 25 miles, and particularly preferred less than 10 miles), sound reduction barrier of greater than 1 decibel (and preferably greater than 2 decibels, and particularly preferred greater than 5 decibels) between the left side of the vehicle and the right side of the vehicle, and further a structural support for at least one passenger seat (and preferably a passenger seat that faces the side of the vehicle, as opposed to forward or backward side of the vehicle). A particular preferred passenger seat is in structural communication with the center queueing lane, and folds upward during logistics mode (with a reduction of dischargeable cargo loading or unloading interference by at least 50% with an adjacent queueing lane and preferably by at least 80% and particularly preferred by at least 90%). The reconfigurable passenger seat being in structural communication with the center queueing lane goes beyond prior art by not only minimizing interference to dischargeable cargo while in logistics mode, but it reduces noise impact of the left side of the vehicle to the right side of the vehicle when in passenger mode.

The smaller swappable energy storage “battery” module within the center queue as an energy density that is at least 5% higher than energy storage modules not within the center queue batteries (and preferably at least 10% higher, and particularly at least 20% higher). The smaller swappable energy storage battery module is also rated with a faster charging rate that is at least 5% higher than energy storage modules not within the center queue batteries (and preferably at least 10% higher, and particularly at least 20% higher). And the smaller swappable energy storage battery module is also rated with a full depth of discharge cycle lifetime that is at least 5% higher than energy storage modules not within the center queue batteries (and preferably at least 10% higher, and particularly at least 20% higher). The utilization of the center queue enables battery swapping that is at least 15% faster than energy storage modules not within the center queue batteries (and preferably at least 25% higher, and particularly at least 50% higher). The swappable battery module within center queue has a height to width ratio that that is at least 15% higher than energy storage modules not within the center queue batteries (and preferably at least 25% higher, and particularly at least 50% higher). The external housing of the center queue, relative to the internally stored swappable battery module, also functions as a guide rail and/or barrier between a left and a right-side queueing lane. The center queue within internally stored swappable battery module has benefits of reducing battery module theft by being within the interior of the vehicle thus effectively eliminating external access to the battery module, which is of particular importance due to the inherent requirement of battery access and swapping capability that reduces structural locking with the vehicle structure. The vertical orientation of the swappable battery storage enables a lower height for the loading or unloading of dischargeable cargo as well as passengers, as compared to the otherwise requirement of putting more battery energy storage in the traditional floor of the electric vehicle. It is understood that a vehicle that leverages only one queueing lane is best when that queueing lane is a vertical oriented center queue, especially when the vehicle is a shared vehicle where the center queue separates a left and right side creating at least two distinct privacy pods for passengers to benefit from increased privacy, increased isolation for reduced air cross-contamination, increased sound isolation, and increased security through isolation of passenger contact between the left and right side of the vehicle. A particularly preferred swappable energy storage module has a collapsible landing gear, where the landing gear in the collapsed mode can freely move within the center queue and in the extended mode is able to freely move from the discharged position to a second position for easy movement to the second position for subsequent recharging. The landing gear further enables ease of movement by a future passenger about to embark on a trip from the current first position to a second position. The preferred center queue has at least a portion of the track in which the swappable energy storage module loads and unloads into the vehicle that reconfigures from a loading or unloading position to a safety (or directional change) position enabling the passenger to move from the left to the right side of the vehicle (or vice-versa). It is understood that the safety position in a relatively long vehicle can have the center queue occupy less than 90% of the vehicle length such that the center queue void of at least 10% is towards the first side of the vehicle opposite of the vehicle's second side in which the swappable energy storage module loads and unloads onto the vehicle.

The center queue preferably also contains the passenger required environmental control devices (or enables thermal isolation for distinct temperature zones between the left and right side of the vehicle for logistics purposes e.g., refrigeration temperature vs. non-refrigerated temperature). Containment of vehicle service components within the center queue is preferred to not interfere with movement within the exterior “other” queueing lanes, such as vehicle service components including power distribution, air conditioning or heating, interior lighting. Another advantage of the center queue is the reduction of damage that could occur during a vehicle crash.

The vehicle having an energy storage system comprised of a first energy storage module that is swappable and a second energy storage module that is not swappable (or at least not contained within the multi-queue lane vehicle, meaning less accessible than the first swappable energy storage module within at least one of the queueing lanes within the multi-queue lane vehicle (and preferably the center queueing lane) features an energy storage management controller that operates in an intentionally unbalanced charging and discharging mode, preferably the controller is a feedforward controller that regulates both the charging and discharging rate as a function of the vehicle's next (or preferably as a function of the next two) charging stations (i.e., docking port for charging or swapping the first swappable energy storage module) as a function of time “f(t)” of the scheduled time at each projected docking port. Contrary to a traditional electric vehicle in which each battery pack (i.e., interchangeable with energy storage module) is desired to be charged and discharged at equivalent rates in order to maximize battery pack system lifetime, the inventive vehicle feedforward controller operates the two distinct energy storage module (first of swappable, and second of non-swappable) such that the rate of discharge of the swappable energy storage module is at least 5% higher than the rate of discharge of the non-swappable energy storage module when the vehicle is able to reach the vehicle's next charging station/docking port predominantly on energy withdrawn from the swappable energy storage AND the next charging station has an available replacement (i.e., interchangeable) swappable energy storage module that has a higher stored energy loading greater (by at least 5%, preferably at least 20%, and particularly preferred at least 80%) than the first swappable energy storage module (i.e., relatively discharged battery). The feedforward controller utilizes both the scheduled charging time at the vehicle's first next charging station AND the vehicle's second next charging station to modulate the discharge rate of the first swappable energy storage module (i.e., higher discharge rate) distinct from the discharge rate of the second non-swappable energy storage module (i.e., lower discharge rate) resulting in the vehicle's idle time being lower (by at least 5%, preferably at least 20%, and particularly preferred at least 80%) as compared to recharging non-preferentially between the swappable energy storage module and the non-swappable energy storage module. The inventive feedforward controller utilizes an approximately equivalent discharge rate for both the first swappable energy storage module and the second non-swappable energy storage module in the event that next charging station (or the next two charging stations) do not have any projected available interchangeable swappable energy storage, any projected available interchangeable swappable energy storage with a projected higher energy capacity at the projected time of energy storage swapping, or the aggregate energy consumption to reach the next charging station (or the next two charging stations) exceeds the remaining energy storage capacity of the first swappable energy storage module and exceeds at least 25% (and preferably at least 50%) of the remaining energy storage capacity of the non-swappable energy storage module. The particularly preferred feedforward controller regulates the discharge rate of the swappable energy storage module to the slowest rate (though faster than the rate of the non-swappable energy storage module) possible (i.e., calculate the projected energy consumption required for the vehicle to reach the next station or the next two charging stations, then to calculate the slowest rate required to have the vehicle's swappable energy storage module capacity be at most 20% remaining capacity of the depth of full discharge level, or preferably at most 10% remaining or particularly preferred at most 5% remaining) and therefore establish a ratio of discharge rate to the swappable energy storage module to the discharge rate to the non-swappable energy storage module. This feature achieves the higher value of minimizing the vehicle idle time due to energy storage module recharging as compared to the increased amortization cost of the otherwise excess strain of the higher discharge rate and/or the higher depth of discharge impact on the swappable energy storage module lifetime operating costs. In other words, the feedforward controller chooses to reduce the swappable energy storage remaining operating lifetime as compared to maintaining an approximately equal discharge rate between the swappable energy storage module and the non-swappable energy storage module (i.e., the condition of swappable energy storage module discharge rate ratio to the non-swappable energy storage module discharge rate ratio greater than 1:1, preferably greater than 1.2:1, and preferably greater than 1.5:1).

Another embodiment of the multi-queue lane vehicle has at least two on-board queueing lanes vertically shifted (one relatively above the other) or horizontally shifted (one relatively adjacent in parallel to the other), preferably where the primary (or heavier) of the dischargeable cargo is placed on the lower level when one first queueing lane is vertically shifted relative to the other second queueing lane. It is understood that multiple levels of queueing lanes can be present in the multi-queue lane vehicle, in addition to at least one vertical shifted queueing lanes can also have two horizontally shifted queueing lanes to provide additional independent queueing sequences leading to the highest degree of vehicle routing options. The additional independent queueing sequences provides the highest level of interspersed forward and reverse logistics routing options therefore minimizing by at least 5% (and preferably at least 10%, and particularly preferred at least 25%) the aggregate distance the multi-queueing lane vehicle travels while accommodating all forward and reverse logistics deliveries, as opposed to being restricted to forward logistics followed by reverse logistics. The multi-queueing lane vehicle is in wireless communications with a feedforward control system that coordinates a network of multi-queueing lane vehicles allocating each vehicles routing sequence by maintaining each queueing lanes sequence order where each queueing lane is deconstructed into a queueing sequence for each accessible loading/unloading corresponding to each entry/exit point (i.e., when the queueing lane is rotatable or the vehicle has the ability to align into a docking port in both the forward or backward position. Routing system maintains parameters for vehicle to include: a) docking direction as a function of queueing position of dischargeable cargo, b) docking position at docking port, c) earliest allowed arrival time, d) latest allowed arrival time, e) projected unloading of dischargeable cargo as a function of queueing position of dischargeable cargo, f) predicted depth of discharge of both swappable vehicle energy storage and non-swappable vehicle energy storage, g) projected arrival time preferably updated in real-time. Given the nature of shared resources (i.e., dischargeable cargo) within the queueing lanes, the feedforward control system maintains the multiple docking port addresses for each dischargeable cargo since shared resources are approximately (or completely) interchangeable between the various docking port addresses. In other words, the substantial increase of potential docking ports (i.e., destination addresses) for interchangeable dischargeable cargo virtually requires a multi-queueing lane vehicle especially when vehicle is autonomous (i.e., no vehicle personnel operator, and therefore no vehicle personnel loader/unloader). To that end, it is optimal for each queueing lane to be designated at least temporarily as either a forward logistics queueing lane or a reverse logistics queueing lane, though it is understood that the designation can dynamically change from a first queueing lane being a forward logistics queueing lane that following all deliveries within this queue that same first queueing lane becomes a reverse logistics queueing lane in which that status is communicated and verified to the feedforward control system.

Another embodiment of the at least two queueing positions is when either of the queueing positions switches to a reverse logistics position temporarily when a subsequent reverse logistics task becomes a subsequent forward logistics prior to delivering a next reverse logistics or a next forward logistics task from within that queueing position. In other words, a queueing lane that has at least one forward logistics dischargeable cargo within its queue if there is adequate space within that queue a next dischargeable cargo item can be loaded in which that last dischargeable cargo is scheduled for a reverse logistics dischargeable cargo thus temporarily blocking access to that queueing lane dischargeable cargos from any forward logistics dischargeable cargo delivery. The feedforward control system must maintain not only a database of dischargeable cargo linked to a specific delivery address (i.e., docking port) within an assigned delivery vehicle, but the position of each dischargeable cargo within the queueing lane and the precise sequence of dischargeable cargos within the queueing lane at all times, and also the status of the dischargeable cargo being a forward logistics or reverse logistics cargo, the projected status (as well as location) of any service assets that are qualified to perform a service on the reverse logistics dischargeable cargo, at least one of the earliest and the latest docking port time slot availability, at least one of the earliest and the latest requirement for dischargeable cargo at a specified docking port, and qualification status of a docking port to unload a specific categorized dischargeable cargo (e.g., size, weight or service function limitations). Furthermore, the interchangeability of each dischargeable cargo to other dischargeable cargos within the same vehicle or different vehicles combined with the position (or projected position as a function of time), the time requirements for a dischargeable cargo to be accessible at a specific delivery address and the projected functionality or available capacity at the time of delivery.

The system having at least one resequencing asset provides a system requirement relaxation of the requirement to maintain precise dischargeable cargo sequential order within a queueing lane of the multi-queueing lane vehicle. In other words, the utilization of a resequencing asset provides many additional options for a relatively temporary absence of dischargeable order sequence within any given queueing lane. Any resequencing asset enables the feedforward control system to convert at least a portion of reverse logistics tasks into subsequent newly ordered forward logistics tasks. The system then leverages an in-route re-queueing asset(s) to enable proper sequential delivery of reverse logistics dischargeable cargo that must be delivered prior to arrival at a next re-queueing asset. The feedforward controller can also control the placement of a reverse logistics task queueing without any in-route conversion (or without any resequencing asset) to a series of forward logistics tasks by placing dischargeable cargo into a new sequenced or non-sequenced (if the collective has the same ultimate disembarking/docking destination port) reverse logistics queueing lane onboard of the multi-queueing lane vehicle.

The multi-queueing lane vehicle obtains optimal performance when a docking port also has inventive features. A preferred docking port can receive the multi-queueing lane vehicle such that the docking port also has automated and autonomous operations for the transfer of dischargeable cargo between the vehicle and the docking port. The docking port embodiments have at least one of a vertical shift between a primarily forward logistics and a primarily reverse logistics queueing lane, a rotating queueing lane or a horizontal shift between two (or more) queueing lanes.

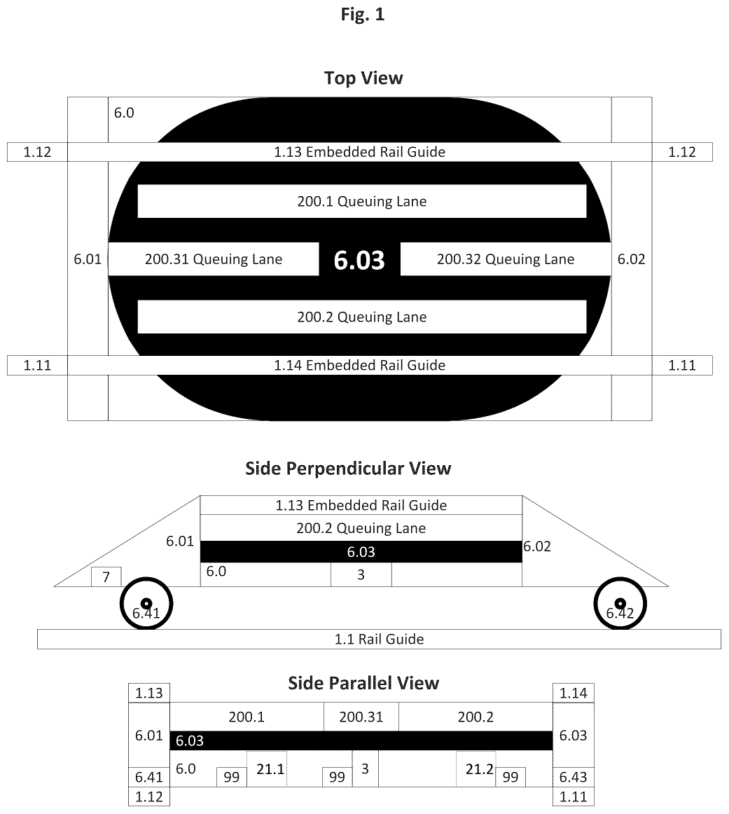

Turning to FIG. 1, FIG. 1 first depicts the Top View of the multi-queueing lane vehicle 6.0. The vehicle 6.0 has at least two queueing lanes, though this exemplary has three queueing lanes 200.1 and 200.2 in addition to the center queueing lane shown here as two distinct non-continuous 200.3 and 200.32 segments (it is understood that the center queueing lane, as well as the other non-center queueing lanes can be either segmented or continuous) providing two distinct queueing access points for loading or unloading of DCs (not shown). The respective queueing lanes are all in structural communications with a queueing floor support 6.03, in which the optional and preferred embodiment has the queueing floor support 6.03 capable of rotating to maximize accessibility by rotating that enables each queueing lane to have two access points (not explicitly stated but by definition being the entry or discharge part of the queueing lane) therefore enabling the loading and/or unloading of DCs at a single location with a single docking port to take place without any vehicle movement in between accessing a first queueing lane and a next (at least a) second queueing lane. The queueing floor support rotates free of any obstruction by the embedded rail guides 1.13 and 1.14 (that are raised, as shown in the Side Perpendicular View and Side Parallel View) while regardless of the rotation angle of the queueing floor support 6.03 a second vehicle (not shown) is able to travel over the first vehicle (shown) by first passing from the wheel supporting lowest guide rail 1.11 (as shown right in Side Parallel View) and 1.12 (as shown left in Side Parallel View) onto the vehicle ramp (as shown on Side Perpendicular View front on ramp if going from front to back of vehicle 6.0) then 1.1 Rail Guide in physical communication guiding the wheels (6.41 left front on Side Perpendicular View, and 6.42 rear on Side Perpendicular View, 6.43 right front) to then the vehicle ramp (as shown on Side Perpendicular View rear off ramp if going from front to back of vehicle 6.0)) and then back onto the wheel supporting lowest guide rail 1.11.

The Side Perpendicular View additionally depicts the track distance sensor 7 that “looks” downward in establishing a precise position of the vehicle in terms of horizontal distance monitoring. The vehicle 6.0 has a pivot point 3 and structural supports 21.1 and 21.2 (shown in Side Parallel View) in physical communications with the vehicle frame (the collective structure as known in the art maintaining integrity of wheels (6.41, 6.42, and 6.43 as shown) ramps 6.01 and 6.02, and a front right wheel not shown) and the queueing floor support 6.03 (above pivot point 3) and the queueing lanes (200.2 as shown and 200.1, 200.31, and 200.32 as shown on Top View; above the floor support 6.03).

The Side Parallel View additionally depicts weight sensor 99 for the determination of the vehicle's queueing floor support 6.03 center of gravity, in which structural supports 21.1 and 21.2 (as shown being preferred circular at a circumference concentric with the pivot point 3) to maintain the queueing floor support 6.03 in an approximately horizontal position even when the center of gravity deviates away from the pivot point 3 (which is especially critical when the queueing floor support 6.03 is rotated for side loading or unloading of DCs, and DCs start to move off of the queueing floor support 6.03 into the docking port not shown). The weight sensor(s) 99 collectively calculate the dynamic center of gravity placement and communicate to the vehicle control system that then coordinates movement of the DCs within the queueing lanes to maintain a sufficient equilibrium in always maintaining the queueing floor support 6.03 in its approximately horizontal position.

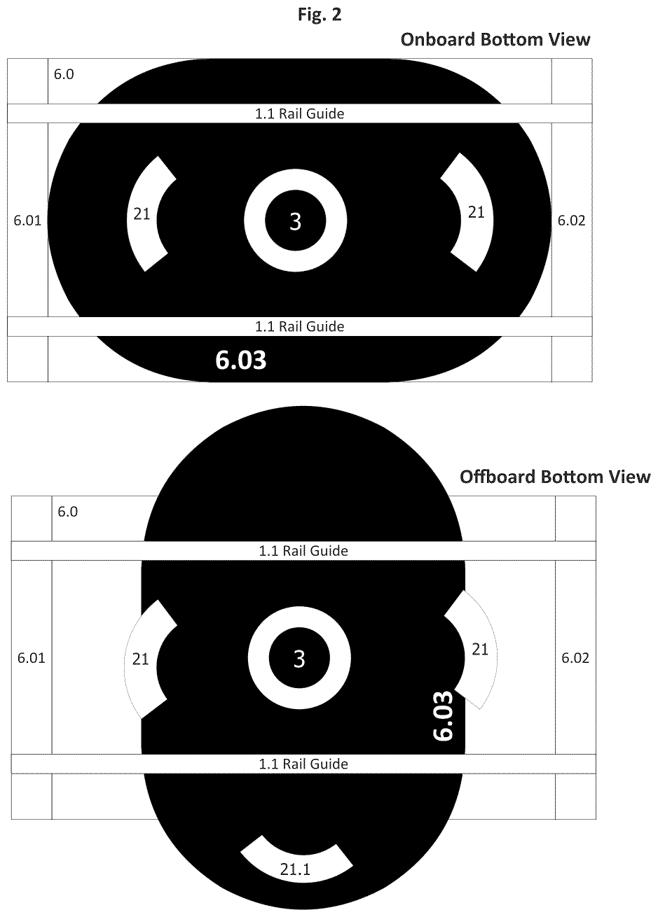

Turning to FIG. 2, FIG. 2 depicts both an Onboard Bottom View and an Offboard Bottom View respectively where the queueing floor support 6.03 is in the vehicle onboard position (i.e., for normal travel, or either front or rear loading or unloading of DCs) or the vehicle offboard position (i.e., for side loading or unloading of DCs). The structural supports 21 as noted in FIG. 1 are on the vehicle and always in structural communications with the vehicle frame, while an additional structural support 21.1 in this instance is optionally placed within the docking port (not shown) and within structural communications to the docking port to further enhance the vehicle's onboard structural supports 21 ability to maintain the queueing floor support 6.03 in its approximately horizontal position.

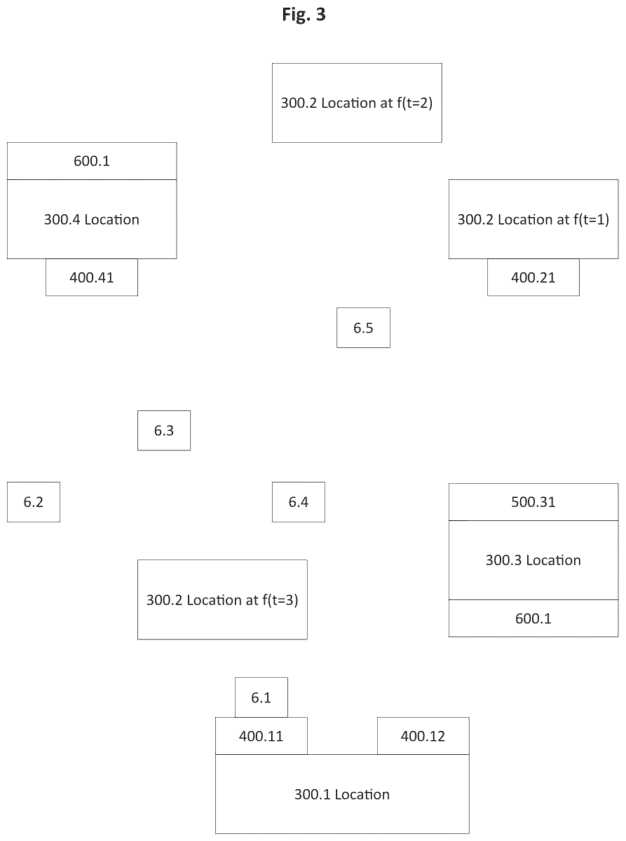

Turning to FIG. 3, FIG. 3 depicts a top-down view of multiple locations geographically spaced as in a 2d map. Locations 300.1, 300.3, and 300.4 are all shown as fixed locations each also having their corresponding queues respectively as 400.11 and 400.12 (docking), 600.1 and 500.31 (service asset queue and resequencing queue), and 400.41 and 600.1 (docking and service asset queue). Location 300.2 (shown at a first physical GPS coordinates with its corresponding docking queue 400.21 for a time function of f(t=1), though not shown at the other next GPS coordinates but still in existence) and then at different GPS coordinates for a time function of f(t=2) and then f(t=3). Vehicles (6.1, 6.2, 6.3, 6.4, and 6.5) are traveling between the different Locations 300.1 through 300.4 with a real-time update of this view being provided to operators of the full multi-queueing system. It is understood that any number of locations can exist in the network, as well as any number of queueing lanes at each location and on each vehicle, and any number of vehicles traveling amongst the locations on dynamically determine routing vectors (not shown on this figure).

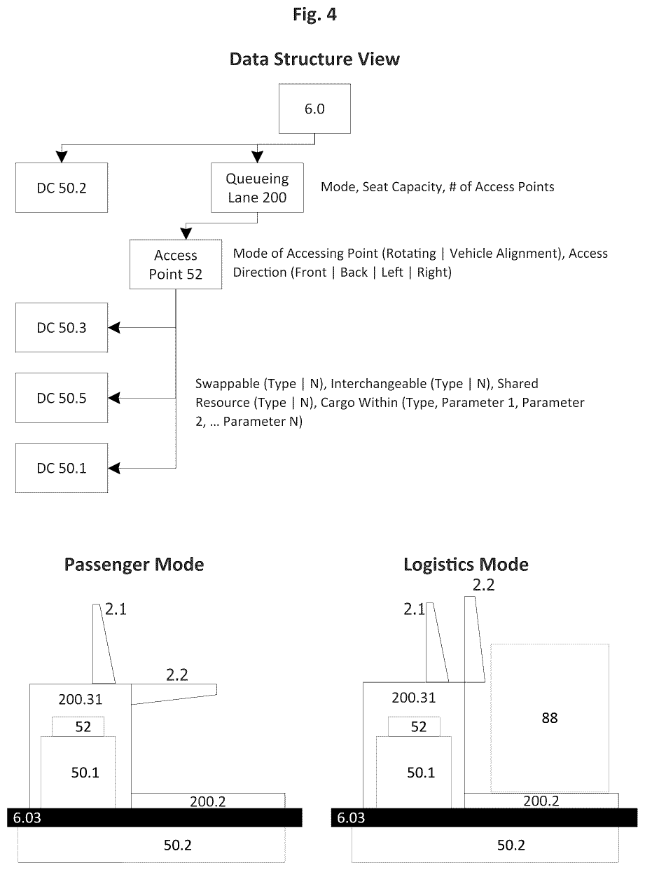

Turning to FIG. 4, FIG. 4 depicts first the data structure view beginning in this instance for the vehicle 6.0 as the parent to each queueing lane 200, having a minimum set of parameters including {Mode (Passenger|Logistics), Seat Capacity, and # of Access Points} as well as any specialized objects notably a non-swappable energy storage 50.2, having a minimum set of parameters including {depth of discharge, energy density, cycle lifetime, full depth of discharge cycles equivalent, predicted depth of discharge upon arrival; swappable|non-swappable; maximum discharge rate; maximum recharge rate}. It is understood that additional vehicle parameters include vehicle identification number, current GPS location, routing vector number, etc. as known in the art. Each queueing lane 200 has a child object of type access point 52 that then further has children objects of DCs indexed by time of entry into the respective queueing lane such that system always has full knowledge of which DC is in position to discharge as well as which queueing lane has spare capacity to load a DC. In this exemplary 50.3 is closest to the discharge position followed by 50.5 and then 50.1. The data structure inherently knows that a second access point for the same queueing lane will depict the same DCs as for the first access point but in the reverse order. Each access point has a minimum set of parameters including {Mode of Accessing Point (Rotating|Vehicle Alignment), Access Direction (Front|Back|Left|Right) with the fundamental understanding that a rotating access point will have its access point dynamically changing}. Each DC has a minimum set of parameters including {Swappable (Type|N), Interchangeable (Type|N), Shared Resource (Type|N), Cargo Within (Type, Parameter 1, Parameter 2, . . . . Parameter N)}.

Additional parameters for the queueing lane(s) include height of lane, width of lane, alignment center in relationship to a vehicle center point docking within that respective queueing lane, # of containers within queue, and limitations for DCs including weight, size, and types of contents within DC acceptable to load or unload relative to queueing lane. Each queueing lane also has operational scheduling parameters as a f(t) at a minimum including earliest arrival time at docking port, latest arrival at docking port for each potential designation docking port, switchable (inbound|outbound) which establishes direction of routing vector.

Additional parameters for the specific DC type of energy storage at a minimum include Swappable Energy Storage: Non-Swappable Energy Storage Capacity Ratio, Swappable Energy Storage: Non-Swappable Energy Storage Discharge Threshold Ratio, and Swappable Energy Storage: Non-Swappable Energy Storage Recharge Threshold Ratio.

A docking port is fundamentally a vehicle position alignment into the Location. As the vehicle at the docking port can have multiple queueing lanes, the docking port itself can (and preferably) can serve that vehicle's queueing lanes without any subsequent movement of the vehicle. The ability to service the multiple queueing lanes of the vehicle is preferably coordinated by having each docking port with each of its queueing lanes having an availability schedule as f(t) which at a minimum includes at least one of the earliest and the latest docking port time slot availability, at least one of the earliest and the latest requirement for dischargeable cargo at a specified docking port, and qualification status of a docking port to unload a specific categorized dischargeable cargo (e.g., size, weight or service function limitations). Docking ports capable of supporting vehicles having multiple queueing lanes preferably has a parameter that regulates whether a vehicle is required to first (load|unload) a DC.

FIG. 4 also depicts two side views centered round the seating configuration respectively for the Passenger Mode and Logistics Mode. The Passenger Mode has the seat back 2.1 in an upright position (typically fixed all the time, though anticipated it can move but always away from obstructing the ability for DCs to move freely within the Queueing Lane 200.2 i.e., non-center queueing lane) and the seat (i.e., supports seat cushion) 2.2 is in the downward position enabling a passenger to sit. The Logistics Mode has the seat back 2.1 remaining in the upright position but now also the seat 2.2 is in the upward position such that the seat creates minimal interference with a dischargeable cargo “DC” 88. Both Passenger and Logistics Mode has the environmental controls 52 above an Energy Storage 50.1 of a swappable type both contained and in structural communications with the Center Queuing Lane 200.31. And both modes also have an Energy Storage 50.2 of a non-swappable type below the Queueing Lane Floor 6.03 of the vehicle 6.0 (not fully shown) such that the non-swappable energy storage doesn't interfere with the movement of any DC within any of the queueing lanes. When the Energy Storage 50.1 is swappable it is understood to be a specialized DC having a unique type identification to distinguish it from a DC that doesn't have the ability to provide energy enroute to the host vehicle 6.0.

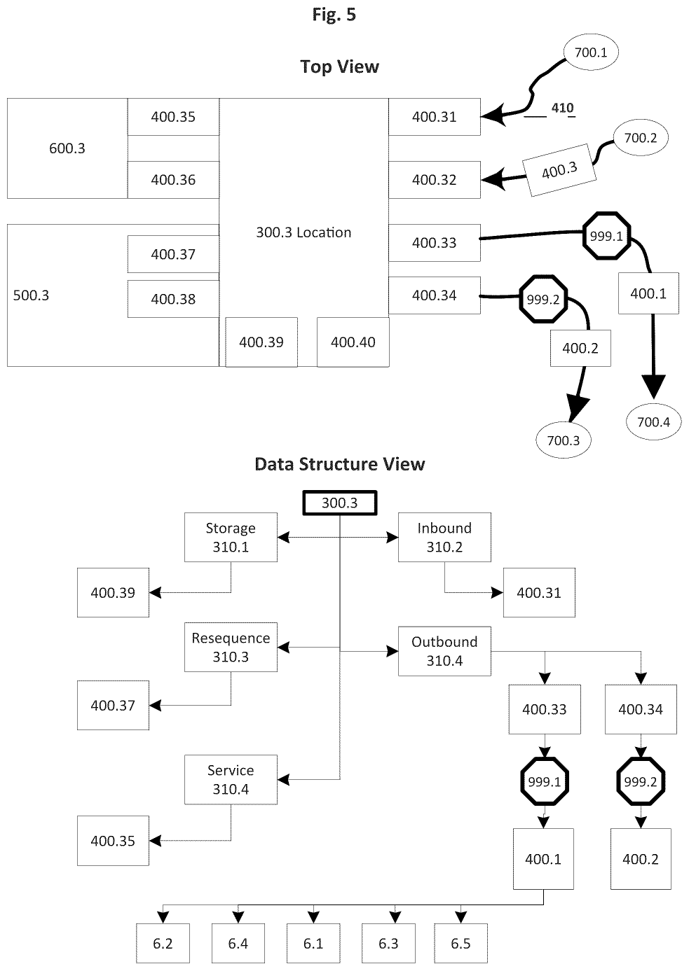

Turning to FIG. 5, FIG. 5 depicts a top view of Location 300.3 having a set of external-facing and internal docking ports. Docking Ports 400.31 and 400.32 are Inbound Docking Ports as further indicated by Routing Vectors 700.1 and 700.2 respectively directed towards the docking ports. Docking Ports 400.33 and 400.34 are further indicated by Routing Vectors 700.4 and 700.3 respectively directed away from the docking ports. The Routing Vector 700.1 has a parking angle 410 with respect to angle of routing vector to a perpendicular angle to the docking port indicative of the desired angle that a vehicle should park into the docking port. The Routing Vector implicitly is a queueing lane (as indicated by 400.3, 400.2, and 400.1) as any vehicle that is following a same Routing Vector will automatically follow in sequence any vehicle that is in front of it relative to Inbound Port (or in front of it relative to Outbound Port). Those same Routing Vectors may optionally have Intermediate Stopping Points (i.e., analogous to traffic lights) 999.2 and 999.1 which are predominantly for the purpose of controlled changes to an alternative routing vector or a time buffer in which the current routing vector is to be replaced with an alternative routing vector. Each location can optionally have internal docking queues 400.39 and 400.40 that effectively enable last in first out “LIFO” or first in first out “FIFO” storage buffers. It is understood that the internal docking queue can be as known in the art an automated storage and retrieval system “ASRS” or in fact another routing vector (though not shown as such). The Location 300.3 in most instances not only receives dischargeable cargo “DC” via Inbound Ports or ships DCs via Outbound Ports, but additionally has the ability to resequence DCs via resequencing queues 400.37 and 400.38 for the purpose of enabling the sequence of DCs from a first queueing lane on a first vehicle to be altered for varying the sequence onto that same first queueing lane on that first vehicle (or to a different queueing lane on that same first vehicle, or to any queueing lane on a second vehicle). When the Location 300.3 has an integral service function it will also contain service queueing lanes 400.35 and 400.36 for buffering DCs prior to performing the integral service function. It is understood that each queueing lane can be a FIFO, LIFO or ASRS type with the FIFO and LIFO being represented by a routing vector (or the simplest routing vector being a straight line).

FIG. 5 also depicts a data structure view, notably a parent-child object-oriented structure. An exemplary data structure starts with the Location 300.3 being a parent to every queueing lane, every DC (not shown, but would be a child of the queueing lane), and every vehicle. A data container, as shown is a queueing lane for each type of queueing storage/lane/buffer such as Storage Queueing 310.1, Resequence Queueing 310.3, Service Queueing 310.4, Inbound Queueing 310.2, and Outbound Queueing 310.4. The respective queueing storage types have at least one queueing lane such as 400.39, 400.37, 400.35, 400.31, and both 400.33 and 400.34. Each queueing lane can have a Routing Vector (or a simple line vector) as a child, with optional Intermediate Stopping Points 999.1 and 999.2 noted along the length of the Routing Vector (the position and quantity can be dynamic) also as a child of the queueing lane, and finally (as shown for queueing lane 400.33) vehicles in sequential order by index of time entered routing vector of vehicles 6.5 then 6.3, 6.1m 6.4 and finally 6.2. Though not shown, the data structure continues its parent-child relationship such that each vehicle then has a child each of its queueing lanes with every DC that is within its respective queueing lane again indexed by its time entered the queueing lane (to know the precise sequence). If the queueing lane has two access points it is understood that each access point can make available, the DC closest to its respective access point for discharge from that queueing lane. The inventive nature of the system needing to support autonomous vehicle operations requires that each Location have at the minimum its precise GPS coordinates and orientation angle, and that each external-facing queueing lane must also have its precise GPS coordinates and orientation angle for which its routing vector is then oriented into.

Though not shown, each Service Queueing area has at least one service asset to perform a specific function on a DC with a parent-child relationship for that service asset as a child to a specific Service Queueing. Each service asset has at a minimum a service availability as a function of time “f(t)”, and preferably a servicing time that can vary depending on the characteristics of the service that needs to be performed on each variation of a DC. In this capacity, the residence time of each DC can be calculated to include inbound queueing time, service time, internal queueing time, outbound queueing time, and finally routing travel time. These same series of cumulative times is also available for Resequencing Queueing. Each queueing lane, whether it be stationary in the Location 300.3 or internal of the vehicle, has an availability schedule as f(t) and at the minimum an internal travel time (or more detailed function) to account for DC entering and discharging from that queueing lane.

A summary of the Outbound Docking Ports as a dynamic Location selection is based on at least two inbound queues: 1) inbound docking for inbound, and then 2) resequencing asset queue and/or service asset queue; and then optionally at least two outbound queues for 3) storage buffer queue (optional) and outbound docking and then 4) vehicle availability with travel time. Calculations of time add any actual process time for each step plus buffering time to provide an estimated arrival time for each DC at a next destination. The inventive routing system makes decisions based on a priority basis amongst various DCs (including with any revenue and penalty bias contributing to the priority basis), as well as an aggregate for all DCs for their aggregate revenue and penalty basis. It is understood that an inbound docking port can (and in most instances will continuously modulate between effectively an inbound mode and outbound mode) to become an outbound docking port and vice versa.

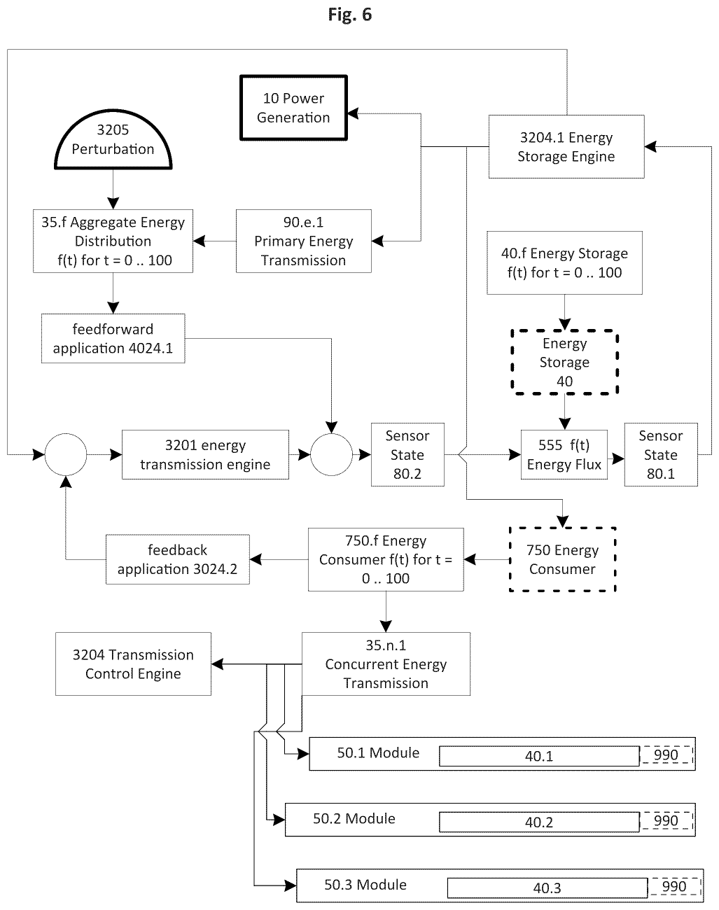

Turning to FIG. 6, FIG. 6 is a process logic flow diagram of the controller depicting the feedforward with feedback architecture such that each connected (and notably those that have communications capability with the distributed control system e.g., IoT or M2M as known in the art) energy storage 40, power generation 10 generator, and energy consumer 750 is directly or at least indirectly via regulator/switch 990 state maintains current and voltage thresholds through the concurrent energy transmission segments 35.n.1 as shown to modules 50.1, 50.2, and 50.3 each having an optional energy storage device respectively 40.1, 40.2, and 40.3 as collectively controlled by the transmission control engine 3204. The feedforward portion of the control system preferably provides power generation signals (or at least is responsive to power sources as made available by power generation 10 generators (including energy storage devices external of the distributed control system) through the primary energy transmission grid 90.e.1 (understood to be at least one source, such that the system has a primary energy transmission grid for each type of energy source e.g., electric vehicle charging, thermal cold or thermal hot) creating an aggregated energy distribution collective 35.f as a function of time. The perturbation engine 3205 in combination with the feedforward application(s) 4024.1 for each type of energy flow improves the feedback portion of the control system responding to real-time actions definitively maintaining each vector and each segment and each energy storage device and each energy consumer within their respective operating envelope (i.e., below their maximum thresholds such as obtained by sensor state 80.2 e.g., voltage and sensor state 80.1 current) to regulate energy flux/flow 555 in real-time to each connected energy storage 40 device becoming an aggregated energy storage as a function of time 40.f. The feedback portion also includes at least over-riding regulation and control of energy consumer(s) 750 through an aggregated function of time 750.f for each type of energy through the feedback application 3024.2. It is a fundamental inventive aspect of the system such that concurrent energy storage charging within an individual vector/segment occurs with energy storage discharging within a different individual vector/segment such that additional energy flow capacity within a given vector/segment is utilized to greatly reduce (by at least 5%) instances in which energy consumers do not have adequate energy flow through its respective energy flow pathways to meets it real-time energy demand. The fundamental objective is such that the energy flow pathway from the power generation 10 generator is never required to meet the real-time demand of any given energy consumer 750 to reduce peak transmission capacity through a distributed co-located energy storage 40 device such that at least one energy consumer has at least two individual concurrent energy transmission 35.n.1 pathways to serve peak demand energy consumption. The principal function of the energy transmission engine 3201 is to operate the onboard energy storage devices 50.1, 50.2, and 50.3 as a system through individual energy consumption controlled by 3204 transmission control engine (a.k.a. battery management system for distinct control of energy draw from battery packs) such that intentional unbalanced energy is drawn from the energy storage devices with preferentially higher energy draws to the swappable energy storage devices relative to the non-swappable energy storage devices. Specifically, the feedforward portion of the control system is looking into the future of energy storage device recharging demand of the vehicle and availability (as well as electricity pricing, etc.) of electric vehicle chargers at both the first next stop Location as well as at least the second next stop Location. As a result, the ratio of discharging power in most instances becomes higher for the swappable energy storage devices relative the non-swappable energy storage devices.

In addition, the feedforward controller dynamically changes any parameter for a specific DC including the routing vector to a future docking port(s). As such the wireless communications portion of the feedforward controller communicates to a re-sequencing asset a new sequence order to a projected vehicle of single or multiple DCs by queueing lane and in most instances alters the routing vector for the vehicle. The feedforward controller utilizes all communicated updates such as service asset availability as a f(t).

Parametric updates further include communication of energy storage charge availability at next charging station and second next charging station based on predicted arrival times with predicted residence time at station; receive from vehicle predicted depth of discharge level upon arrival at next station and second next station (assumes no intermittent charging at next station). The controller communicates to each docking port for each DC the next charging rate threshold, the ending charge level prior to leaving docking port, the projected leaving time from docking port; rate is a function of aggregate charging level at next station and second next station including based on charge consumption for travel between next station and second next station.

And the routing vector system maintains parameters for vehicle to include: a) docking direction as a function of queuing position of dischargeable cargo, b) docking position at docking port, c) earliest allowed arrival time, d) latest allowed arrival time, e) projected unloading of dischargeable cargo as a function of queueing position of dischargeable cargo, f) predicted depth of discharge of both swappable vehicle energy storage and non-swappable vehicle energy storage, and g) projected arrival time preferably updated in real-time.

The system provides for a dynamic routing vector for any inbound vehicle, any inbound queueing lane of that inbound vehicle, etc. The system also provides a dynamic routing vector for any outbound vehicle, that is a function of the docking port in which it will dock into, where the routing vector also represents an inherent queueing buffer. It is understood that the system can communicate wirelessly to update any queueing lane or assignment of a vehicle to any queueing lane with an alternative routing vector at any point in time during the vehicle's transit time. The routing vector as noted includes the parking angle, an approach travel angle (provides sufficient travel length for vehicle to achieve the parking angle) and vehicle alignment buffer distance for precise docking alignment at specified angle indicated by routing vector intersection with docking port. The dynamic routing system also provides optional intermediate stopping points along the routing vector to enable changes in queueing order (as necessary) via switching to a new routing vector (which can be solely a change in vectors of effectively the same vector, or effectively the switching of a vehicle from a first routing vector to a different routing vector). The routing system is continuously updating its data structure with the latest information so as every DC is assigned a queueing lane within a specific vehicle, and further the vehicle is assigned a docking port that takes into account which vehicle queueing lane is being used, vehicle size, weight, docking height, alignment method restrictions; and in addition DC size, weight, and type restrictions.

The Dynamic Multi-Queue Logistics System and more specifically the subcomponent of the routing system is in direct communication to an overarching Geographic Mapping System that optimizes the dynamic placement of re-deployable assets based on at least two inbound queues, or based on the at least two outbound queues, or preferably on both the at least two inbound queues and the at least two inbound queues. A re-deployable asset is a Location that in fact can be dynamically relocated from a first GPS location to a second GPS location. The re-deployable asset can be a full-service location having a Service Queueing in addition to an Inbound Queueing and Outbound Queueing (typically also with integral Resequence Queueing and Storage Queueing), or only a resquencing location having only a Resequence Queueing with integral Inbound Queueing and Outbound Queueing). The ability to move this functionality from the first geographic location to the second geographic location enables the system to optimize overall system performance on predominantly reduced operating costs by effectively reducing travel operating costs or fulfillment time within the near-term projected schedule of DC logistics requirements or by an alternative optimization algorithm. The Geographic Mapping System utilizes a feedforward control system with enhanced machine learning capabilities to determine the GPS coordinates (and orientation angle) for the re-deployable assets. Included in the Geographic Mapping System is a data structure containing the availability as a f(t) a range of candidate Locations, along with any parametric limitations also as a f(t) that includes maximum rate of inbound vehicles f(t), maximum aggregate number of inbound vehicles f(t), maximum rate of outbound vehicles f(t), maximum aggregate number of outbound vehicles f(t), maximum rate of inbound DC f(t), maximum aggregate number of inbound DC f(t), maximum rate of outbound DC f(t), and/or maximum aggregate number of outbound DC f(t), or combination thereof. The Geographic Mapping System must further communicate to each vehicle the updated GPS location and orientation angle at a minimum and preferably also the Routing Vector to the assigned docking port. It is understood that the Geographic Mapping System communicates enroute to the vehicle a new Routing Vector reflecting all updated information, such as the vehicle approaches the Location the Geographic Mapping System will constantly be updating the Routing Vector to reflect at the least more specificity such as the first Routing Vector only gets the vehicle within a close proximity to the Location while the next Routing Vector gets the vehicle not only to the Location but has specific routing vectors to the Location and to the correct Queueing lane. One notable exemplary Location has the service function of vehicle electric vehicle charging. To that end, the Geographic Mapping System simulates using the inventive feedforward control system the queueing probability mapping taking into account projected queueing of vehicles, projected state of charge for those projected queueing vehicles with their projected arrival times, and further projected electrical demand and electricity rates f(t) as part of the charging profile f(t) for each vehicle at a first Location, and then at least one next Location based on the routing vector for logistics requirements of current and/or projected DC logistics requirements.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A multi-queueing lane vehicle consisting of:
a body floor panel in structural communications with an at least two queueing lanes
the at least two queueing lanes consists of a first queueing lane to serve a routing to unload an at least two dischargeable cargos in a forward logistics mode;
the at least two queueing lanes consists of a second queueing lane to serve as a routing to unload the at least two dischargeable cargos in the forward logistics mode at an at least first set of docking ports and then able to serve the routing to load an at least one dischargeable cargo in a reverse logistics mode at an at least second set of docking ports;
a wireless communications with a vehicle routing control system to sequence the routing from the at least first set of docking ports to the at least second set of docking ports; and then to
an at least third set of docking ports in which either the at least two dischargeable cargos in the forward logistics mode or the at least one dischargeable cargo in the reverse logistics mode is unloaded at the at least third set of docking ports.

2. The multi-queueing lane vehicle as claimed in claim 1 further consisting of a center queueing lane in between a first queuing lane of the at least two queueing lanes and a second queueing lane of the at least two queueing lanes, whereby the center queueing lane is in structural communication with the multi-queueing lane vehicle body floor panel and an at least one upward folding seat within the at least two queueing lanes, whereby the at least one upward folding seat is in an operational downward seating position when the at least two queueing lanes is in a passenger mode and the at least one upward folding seat is in an upward non-seating position when the at least two queueing lanes is in a logistics mode.

3. The multi-queueing lane vehicle as claimed in claim 1
whereby the at least two queueing lanes is further consisting of an at least one swappable energy storage device in structural communications with the at least two queueing lanes;
whereby the multi-queueing lane vehicle is further consisting of an at least one non-swappable energy storage device in structural communications with the body floor panel; and
whereby the at least one swappable energy storage device has an aggregate swappable energy storage capacity and whereby the at least one non-swappable energy storage device has an aggregate non-swappable energy storage capacity and whereby the ratio of the aggregate non-swappable energy storage capacity to the aggregate swappable energy storage capacity is greater than 1.

4. The multi-queueing lane vehicle as claimed in claim 3 further consisting of:
a center queueing lane in between a first queuing lane of the at least two queueing lanes and a second queueing lane of the at least two queueing lanes;
whereby the center queueing lane is in structural communication with the multi-queueing lane vehicle body floor panel; and
whereby the center queueing lane is further consisting of the at least one swappable energy storage device.

5. The multi-queueing lane vehicle as claimed in claim 3
whereby the at least two queueing lanes is further consisting of an at least one swappable energy storage device in structural communications with the at least two queueing lanes;
whereby the multi-queueing lane vehicle is further consisting of an at least one non-swappable energy storage device in structural communications with the body floor panel; and
whereby the at least one swappable energy storage device has a maximum swappable energy storage recharge rate and whereby the at least one non-swappable energy storage device has a maximum non-swappable energy storage recharge rate and whereby the ratio of the maximum non-swappable energy storage recharge rate to the maximum swappable energy storage recharge rate is less than 1.

6. The multi-queueing lane vehicle as claimed in claim 3
whereby the at least two queueing lanes is further consisting of an at least one swappable energy storage device in structural communications with the at least two queueing lanes;
whereby the multi-queueing lane vehicle is further consisting of an at least one non-swappable energy storage device in structural communications with the body floor panel; and
whereby the at least one swappable energy storage device has a maximum swappable energy storage discharge rate and whereby the at least one non-swappable energy storage device has a maximum non-swappable energy storage discharge rate and whereby the ratio of the maximum non-swappable energy storage discharge rate to the maximum swappable energy storage discharge rate is less than 1.

7. The multi-queueing lane vehicle as claimed in claim 3
whereby the at least two queueing lanes is further consisting of an at least one swappable energy storage device in structural communications with the at least two queueing lanes;
whereby the multi-queueing lane vehicle is further consisting of an at least one non-swappable energy storage device in structural communications with the body floor panel;
whereby the at least one swappable energy storage device is operated at an operating swappable energy storage discharge rate and whereby the at least one non-swappable energy storage device is operated at a non-swappable energy storage discharge rate and whereby the ratio of the operating non-swappable energy storage discharge rate to the operating swappable energy storage discharge rate is less than 1 for an unbalanced discharge operating time greater than 2 minutes during a multi-queueing lane vehicle trip prior to reaching a swapping station to exchange a current swappable energy storage device having a current swappable energy storage capacity level on the multi-queueing lane vehicle less than a replacement swappable energy storage capacity level;
whereby the current swappable energy storage capacity level is lower by at least 5 percent than the replacement swappable energy storage capacity level; and
whereby the at least two queueing lanes consists of a first queueing lane to serve a routing to unload an at least two dischargeable cargos in a forward logistics mode.

8. The multi-queueing lane vehicle as claimed in claim 1 whereby the at least two queueing lanes switches at least once between the forward logistics mode and the reverse logistics mode while enroute between the first set of docking ports and either the second set of docking ports and the third set of docking ports.

9. The multi-queueing lane vehicle as claimed in claim 1 whereby the at least two queueing lanes further consists of a first access point and a second access point becoming a dual access queuing lane providing a last in first out sequence of a set of dischargeable cargo within the dual access queueing for each of the first access point and the second access point.

10. The multi-queueing lane vehicle as claimed in claim 1 whereby a shareable dischargeable cargo is within the set of dischargeable cargo.

11. The multi-queueing lane vehicle as claimed in claim 1 whereby an interchangeable dischargeable cargo is within the set of dischargeable cargo.

12. The multi-queueing lane vehicle as claimed in claim 1 whereby the at least two queueing lanes has a set of queueing limitations defined by an at least two parameters including queueing lane height, queueing lane width, queueing lane center of alignment displacement from a center point of the multi-queueing lane vehicle, maximum dischargeable cargo height, maximum dischargeable cargo width, maximum dischargeable cargo weight, and maximum number of dischargeable cargo in queueing lane.

13. The multi-queueing lane vehicle as claimed in claim 9 whereby the multi-queueing lane vehicle has a first movement to align and dock into either the at least first set of docking ports, the at least second set of docking ports or the at least third set of docking ports; and wherein the multi-queueing lane vehicle unloads an at least one dischargeable cargo from the set of dischargeable cargo through the first access point and then loads the at least one dischargeable cargo from the set of dischargeable cargo through the second access point or wherein the multi-queueing lane vehicle loads an at least one dischargeable cargo from the set of dischargeable cargo through the first access point and then unloads the at least one dischargeable cargo from the set of dischargeable cargo through the second access point without the multi-queueing lane vehicle moving after the first movement to align and dock.

14. The multi-queueing lane vehicle as claimed in claim 13 whereby the multi-queueing lane vehicle is further consisting of a queueing lane pivot point wherein the at least one queueing lanes rotate around the queueing lane pivot point to switch loading or unloading of the at least one dischargeable cargo between the first access point to the second access point or the second access point to the first access point.

15. The multi-queueing lane vehicle as claimed in claim 13 whereby the multi-queueing lane vehicle is a first fleet vehicle from within an entire fleet of multi-queueing lane vehicles; whereby the vehicle routing control system to sequence the routing of each multi-queueing lane vehicles from the fleet of multi-queueing lane vehicles between the at least first set of docking ports to the at least second set of docking ports and then to an at least third set of docking ports is further consisting of a database for each of the first access point and each of the second access point of each of the at least two queueing lanes of each of the multi-queueing lane vehicles within the fleet of multi-queueing lane vehicles; whereby the database has an object record for each of the at least one dischargeable cargo including a sequence parameter and an unique identification parameter, and whereby the sequence parameter for each of the at least one dischargeable cargo is in a last in first out basis.

16. The multi-queueing lane vehicle as claimed in claim 5 whereby the at least one dischargeable cargo is the at least one swappable energy storage device, and whereby the object record for each of the at least one dischargeable cargo further consists of parameters including depth of discharge, energy density, cycle lifetime, full depth of discharge cycles equivalent, predicted depth of discharge upon arrival at a next docking port, maximum discharge rate, maximum recharge rate.

17. The multi-queueing lane vehicle as claimed in claim 5 whereby the at least one dischargeable cargo is the at least one swappable energy storage device; whereby each of the at least one swappable energy storage device has a height and a width; and whereby the height to width ratio is greater than 2.

18. The multi-queueing lane vehicle as claimed in claim 13
whereby the multi-queueing lane vehicle is a first fleet vehicle from within an entire fleet of multi-queueing lane vehicles;
whereby the multi-queueing lane vehicle is capable of moving to an at least two candidate docking ports of each docking port of the at least first set of docking ports, the at least second set of docking ports, and the at least third set of docking ports;
whereby each of the at least two candidate docking ports is consisting of an at least one queueing access docking lane;
whereby the vehicle routing control system to sequence the routing of each multi-queueing lane vehicles from the fleet of multi-queueing lane vehicles to at least one of the at least one queueing access docking lane of the at least two candidate docking ports; and
whereby the vehicle routing control system is further consisting of a database record for the at least one queueing access docking lane of the at least two candidate docking ports;
whereby the database has an object record for each of the at least one dischargeable cargo including a sequence parameter and an unique identification parameter in the at least one queueing access docking lane of the at least two candidate docking ports;
and whereby the sequence parameter for each of the at least one dischargeable cargo within each of the access points within each of the docking port queueing lane is in a first in first out basis.

19. The multi-queueing lane vehicle as claimed in claim 18 whereby the object record for each of the at least one dischargeable cargo in the at least one queueing access docking lane of the at least two candidate docking ports is further consisting of parameters for each of the docking port queueing lanes including an at least one earliest arrival time and an at least one latest arrival time as a function of time and a function of spare capacity for an at least one additional dischargeable cargo from the at least one dischargeable cargo from the multi-queueing lane vehicle.

20. The multi-queueing lane vehicle as claimed in claim 19 whereby the docking port queueing lane of the at least two candidate docking ports is further comprised of a structural transfer link between the multi-queueing lane vehicle and the at least one queueing access docking lane of the at least two candidate docking ports and an actuator to shift the structural transfer link in a rotating, horizontal, or vertical direction from a first queueing lane of the multi-queueing lane vehicle to a second queueing lane of the multi-queueing lane vehicle without the multi-queueing lane vehicle moving after the first movement to align and dock.
